(19) United States
(12) Patent Application Publication
(10) Pub. No.: US 2024/0087249 A1
(43) Pub. Date: Mar. 14, 2024

(54) PROVIDING MULTIPLE PERSPECTIVES FOR VIEWING LOSSLESS TRANSMISSIONS OF VR SCENES

(71) Applicant: T-Mobile Innovations LLC, Overland Park, KS (US)

(72) Inventor: Ali Daniali, Tukwila, WA (US)

(21) Appl. No.: 17/944,586

(22) Filed: Sep. 14, 2022

(51) Int. Cl. G06T 19/00; G06F 3/14; G06T 7/20; G06T 7/70; G06T 19/20

(52) U.S. Cl. CPC G06T 19/006; G06F 3/14; G06T 7/20; G06T 7/70; G06T 19/20

(57) ABSTRACT

Systems, methods, and computer-readable media herein provide multiple perspectives for viewing lossless transmissions of VR scenes. Tracking and scene data associated with a three dimensional “3D” scene are received and used to determine viewing parameters that define a particular perspective from which to render the 3D for display at a particular recipient device. The tracking and scene data is streamed without compression to recipient devices prior to rendering allowing for dynamic and flexible viewing perspective selection by the recipient devices. The recipient devices may render and display the 3D scene in accordance to a particular viewing perspective.

### BACKGROUND

Virtual and augmented reality provides highly immersive and practical applications in technological areas such as education, science, engineering, entertainment, medicine, and others. The ability to create and manipulate three dimensional “3D” environments provides an engaging and highly customizable experience for users of virtual reality and augmented reality systems. For example, a 3D environment may be designed to act as a virtual classroom, a virtual architectural plan, or video gaming platform. Because 3D environments can be designed to mimic or share properties of a real-life physical environment, users can interact within a VR and AR experience in a manner that is familiar and natural to the users. As VR and AR systems have been adopted in many industries and applications, interest in shared VR and AR experiences has grown, namely, experiences in which a number of users can observe and even interact with a shared 3D environment associated with a source device such as a VR headset that is paired with motion tracking sensors. Often, users sharing a VR experience are in different physical locations across the world and/or using different devices. Thus, to share a VR experience and the associated 3D data and other information related to a shared VR experience, the 3D data and information must be streamed over one or more networks to the devices of each user that is participating in the shared experience.

Streaming a VR experience presents numerous limitations. Rendered VR scenes often include large quantities of data that must be streamed to recipient devices. To preserve a suitably high refresh rate and resolution for VR video data that is streamed, the VR video data must be compressed so that it can be streamed in real-time to the recipient devices while preserving network bandwidth. However, compression of VR video data can result in pixilation, jitter, dropped frames, visual artifacts, and many other conditions that may degrade the experience for users of recipient devices and may disrupt an immersive environment desired in the VR experience. Further, since VR video is rendered on a source device or system before streaming it to the receiving devices, the receiving devices have limited ability to change the perspective or field of view represented in the video. For example, users receiving a streamed VR video may be limited to the same perspective—or several pre-determined perspectives—of a 3D environment as that of the source device since that particular perspective is “baked in” to the rendered 3D video.

### SUMMARY

The present disclosure is directed, in part, to providing multiple perspectives for viewing lossless transmissions of VR scenes, substantially as shown in and/or described in connection with at least one of the figures, and as set forth more completely in the claims. In contrast to conventional approaches, VR data indicative of a 3D scene may be transmitted in a lossless fashion from a source device to a client device (e.g., receiving device or recipient device) without pre-rendering the 3D scene on the source device. For example, a source device (e.g., a personal computer) may transmits tracking data, such as data from a VR headset and/or motion capturing sensor system, or scene data associated with a 3D scene to one or more client devices (or cloud network devices) which may subsequently compose and render the 3D scene. In some embodiments, some or all of the VR data may be transmitted to a client device at a time prior to a time that a 3D scene is rendered at the client device (e.g., at the beginning of a shared VR session). For example, data associated with portions of the 3D scene and/or 3D objects in the scene may be transmitted to, and saved locally on, a client device prior to the time that the portions of the 3D scene or the 3D objects are rendered-if they are rendered at all. Because, the VR data is transmitted to a client device before composing and rendering a 3D scene, compression of a 3D VR media can be avoided while preserving a high quality and highly immersive experience.

In some embodiments, a client device may comprise components for manipulating a virtual camera within a 3D scene to cause the 3D scene to be composed and rendered with a viewing perspective in accordance with the virtual camera. For example, a user of a client device may move a virtual camera within a 3D scene, such that when the 3D scene is rendered at the client device, it may be rendered with a different field of view than that of the source device. As another example, a client device may switch between any number of perspectives, including the perspective of the source device or another device, by using the received VR data to compose and render the 3D scene in relation to a particular perspective or set of perspectives. By using a virtual camera to determine a perspective with which to view a 3D environment, a client device can engage with a 3D scene using perspectives other than those predetermined or dictated by the source device, allowing for more adaptable and flexible interaction with a shared 3D scene.

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

### BRIEF DESCRIPTION OF THE SEVERAL VIEWS OF THE DRAWINGS

Implementations of the present disclosure are described in detail below with reference to the attached drawing figures, which are intended to be exemplary and non-limiting, wherein:

FIG. 1 depicts a diagram of a VR scene transmission system in which implementations of the present disclosure may be employed:

FIG. 2 depicts an example process for lossless VR streaming, in accordance with embodiments of the present disclosure:

FIG. 3 depicts an example process for lossless VR streaming with pre-rendering, in accordance with implementation of the present disclosure:

FIG. 4 depicts a flow chart of a method for generating a 3D rendering, in accordance with aspects of the present disclosure;

FIG. 5 depicts a flow chart of a method for transmitting lossless 3D renderings, in accordance with aspects of the present disclosure;

FIG. 6 depicts a flow chart of a method for streaming 3D VR media, in accordance with aspects of the present disclosure; and

FIG. 7 depicts a diagram of an exemplary computing environment suitable for use in implementations of the present disclosure.

### DETAILED DESCRIPTION

The subject matter of embodiments of the invention is described with specificity herein to meet statutory requirements. However, the description itself is not intended to limit the scope of this patent. The claimed subject matter might be embodied in other ways to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Throughout the description of the present invention, several acronyms and shorthand notations are used to aid the understanding of certain concepts pertaining to the associated system and services. These acronyms and shorthand notations are solely intended for the purpose of providing an easy methodology of communicating the ideas expressed herein and are in no way meant to limit the scope of the present invention.

Further, various technical terms are used throughout this description. A definition of such terms can be found in, for example, Newton's Telecom Dictionary by H. Newton, 31st Edition (2018). These definitions are intended to provide a clearer understanding of the ideas disclosed herein but are not intended to limit the scope of the present invention. The definitions and terms should be interpreted broadly and liberally to the extent allowed by the meaning of the words offered in the above-cited reference.

Embodiments of the technology may be embodied as, among other things, a method, system, or computer-program product. Accordingly, the embodiments may take the form of a hardware embodiment, or an embodiment combining software and hardware. In one embodiment, the present invention takes the form of a computer-program product that includes computer-useable instructions embodied on one or more computer-readable media.

Computer-readable media includes volatile and/or nonvolatile media, removable and non-removable media, and contemplate media readable by a database, a switch, and various other network devices. Network switches, routers, and related components are conventional in nature, as are means of communicating with the same. By way of example and not limitation, computer-readable media comprise computer storage media and/or communications media. Computer storage media, or machine-readable media, include media implemented in any method or technology for storing information. Examples of stored information include computer-useable instructions, data structures, program modules, and other data representations. Computer storage media include RAM, ROM, EEPROM, flash memory or other memory technology, CD-ROM, digital versatile discs (DVDs), holographic media or other optical disc storage, magnetic cassettes, magnetic tape, magnetic disc storage, and/or other magnetic storage devices. These memory components can store data momentarily, temporarily, or permanently. Computer storage media does not encompass a transitory signal, in embodiments of the present invention.

Communications media typically store computer-useable instructions, including data structures and program modules, in a modulated data signal. The term “modulated data signal” refers to a propagated signal that has one or more of its characteristics set or changed to encode information in the signal. Communications media include any information-delivery media. By way of example but not limitation, communications media include wired media, such as a wired network or direct-wired connection, and wireless media such as acoustic, infrared, radio, microwave, spread-spectrum, and other wireless media technologies. Combinations of the above are included within the scope of computer-readable media.

At a high level, systems, methods, and computer-readable media of the present disclosure provide for providing multiple perspectives for viewing lossless transmissions of VR scenes. The systems, methods, and computer-readable media disclosed herein may provide lossless transmission of 3D scenes for presentation in association with one or more devices while supporting multiple and adjustable perspectives within the 3D scene. By transmitting the VR data, such as tracking data and 3D scene data to recipient devices prior to rendering, the bandwidth requirements to transmit the 3D scene is decreased while persevering a high quality and highly immersive experience for the users of receiving devices. Further, by taking advantages of rendering resources (e.g., hardware resources, compute resources) of network devices and/or receiving devices, VR 3D scenes may be transmitted while mitigating any drop in perceived quality by users.

In a first aspect of the present disclosure, a method is provided. In embodiments, the method comprises receiving data indicating a 3D scene associated with a source device. The data indicating a 3D scene may comprise scene data and/or tracking data. Scene data comprises data defining aspects of a 3D scene such as 3D objects, boundaries, appearance, sounds, movements of objects, and/or any other attribute descriptive of a 3D scene or experience. For example, in a 3D scene relating to a sporting event, the scene data may comprise data describing players and their movements, the playing field, the physical properties of the 3D scene, and/or sounds associated with the sporting event. Tracking data may comprises any data indicating the movement or the position of a participant or attendee of a 3D scene. For example, tracking data may describe the movement and position of a user's hand(s), head, and eye(s) and may be captured by VR sensors such as a VR headset and/or a VR rig (e.g., VR system with one or more connected devices) and that corresponds to interactions within a 3D scene.

The method may comprise determining a set of view parameters for rendering a 3D scene at a client device. In some embodiments, a 3D scene may be composed before it is rendered and presented for display in a client device that is receiving a stream of VR media. Composing a 3D scene may comprise configuring the 3D scene such that it can be rendered. For example, composing a 3D scene may involve determining the position, direction, and/or other attributes of one or more virtual cameras within, or placed in association with, a 3D scene. A virtual camera may represent the particular perspective from which a 3D scene is viewed and/or rendered. For example, within a 3D scene a perspective may correspond to the perspective of the user of a source device (e.g., the perspective of a user within a VR headset) or may correspond to any other view (e.g., from one or more virtual cameras). Once the set of view parameters is determined, a rendering of the 3D scene may be generated according to the set of view parameters. For example, based on the deployment of one or more virtual cameras within a 3D scene, the 3D scene may be rendered and presented in a display (e.g., within a VR headset, on a display of a smartphone or 5G device, etc.) of one or more client devices. In some embodiments, multiple client devices associated with the same 3D scene may each have defined different virtual cameras within the 3D scene and may each render distinct representations of the 3D scene based on the respective virtual cameras.

In a second aspect of the present disclosure, a system is provided. The system may comprise one or more processor and one or more computer storage hardware devices storing computer-usable instructions that, when used by the one or more processors, cause the one or more processors to receive data indicating a 3D scene associated with a source device (e.g., a device hosting and/or streaming a VR session or experience). The instructions may further cause the one or more processors to determine a set of view parameters for presentation of the 3D scene at a client device. For example, network devices may include processors and hardware capable of receiving data from a source device, processing the data to determine a set of view parameters, rendering the 3D scene, and transmitting the rendered 3D scene to a destination client device. In such an example, the network devices (e.g., cloud servers, etc.) may perform the data analyzing and scene rendering operation in cases where the recipient client devices lack or have limited resources to perform those operations. The instructions may further cause the one or more processors to transmit the rendering of a 3D scene to one or more client devices. For example, in cases where the rendering is performed by a server on a network, the rendered 3D scene may be streamed to the respective client devices. In some embodiments, a determination of whether to perform rendering operations on a server (e.g., in cloud) or on the destination client devices may be based on the capabilities of the client devices, the bandwidth of the network, a service level, or any other relevant criterion.

In a third aspect of the present disclosure, computer-readable media is provided, the computer-readable media having computer-executable instructions embodied thereon that, when executed, perform a method. In accordance with the media, data corresponding to a 3D scene associated with a source device is received. In some embodiments, the source device may comprise one or more VR sensors (e.g., motion sensor, ultrasonic, laser, audio, inertial, accelerometer sensors, etc.). The data may comprise tracking data, such as data generated by the one or more VR sensors of the source device, and 3D scene data that may define characteristics of the 3D scene. In some embodiments, a set of view parameters for rendering the 3D scene at a client device is determined. For example, the set of view parameters may be based on one or more virtual cameras within the 3D scene. In some embodiments, client devices may generate, modify, manipulate, or otherwise control one or more virtual cameras. For example, users of a client device may provide input to the client device that controls a virtual camera within a particular 3D scene. In some embodiments, a rending of the 3D scene may be generated at the client device. In certain embodiments, the 3D scene is generated in accordance to the determined set of view parameters. For example, a client device may use the determined set of view parameters (e.g., a particular perspective of a virtual camera) to render a 3D scene in accordance with a particular perspective within the 3D scene.

In some embodiments, a 3D scene may be mapped to a physical environment. For example, a 3D scene may be generated such that portions of the 3D scene correspond to a portion of a physical space. As merely one example, a 3D space may be created to represent a physical room that is equipped with VR sensors. In such an example, as a user moves and acts within the physical room, those movements and actions may be mapped to the 3D scene. In some embodiments, a 3D scene received by a client device (e.g., VR headset, VR system, etc.) may similarly be mapped to a physical space associated with the client device. In this way, a 3D space may be mapped to a first physical environment (e.g., associated with the source device) and a second physical environment (e.g., associated with a client device) to allow users of the source device and client device to interact with a shared 3D space within their respective mapped physical environments.

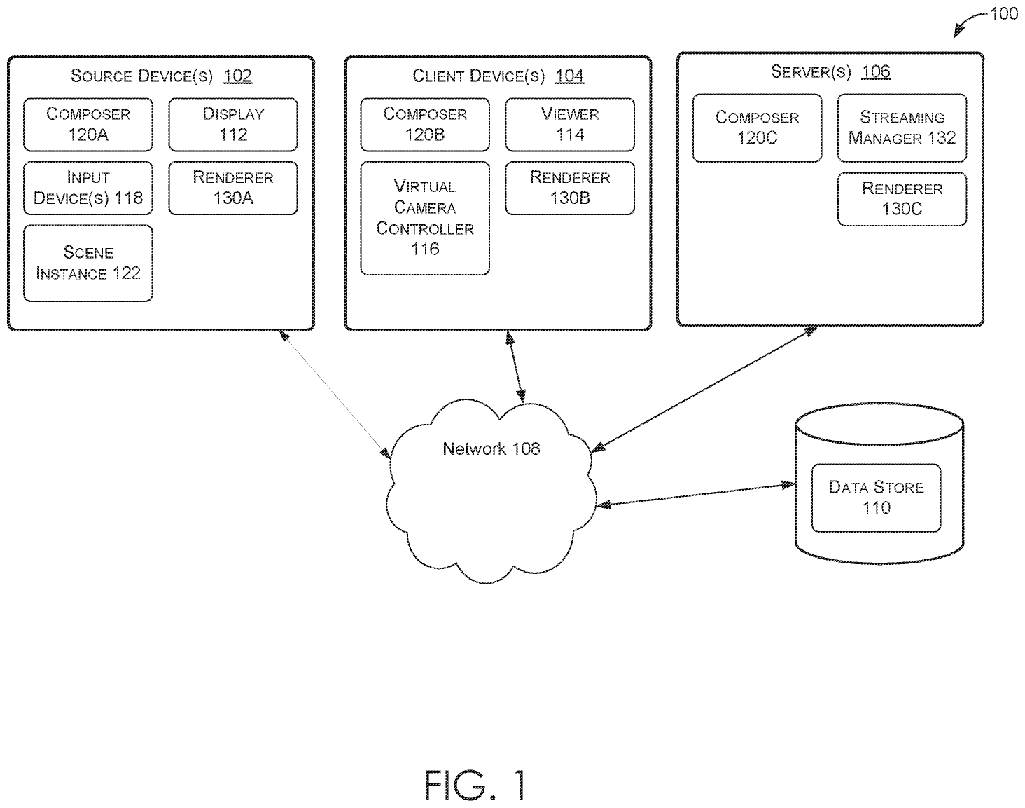

Turning now to FIG. 1, VR scene transmission system 100 is an exemplary system environment in which implementations of the present disclosure may be employed. VR scene transmission system 100 is one example of a suitable network environment and is not intended to suggest any limitation as to the scope of use or functionality of the present disclosure. Neither should the network environment be interpreted as having any dependency or requirement relating to any one or combination of components illustrated.

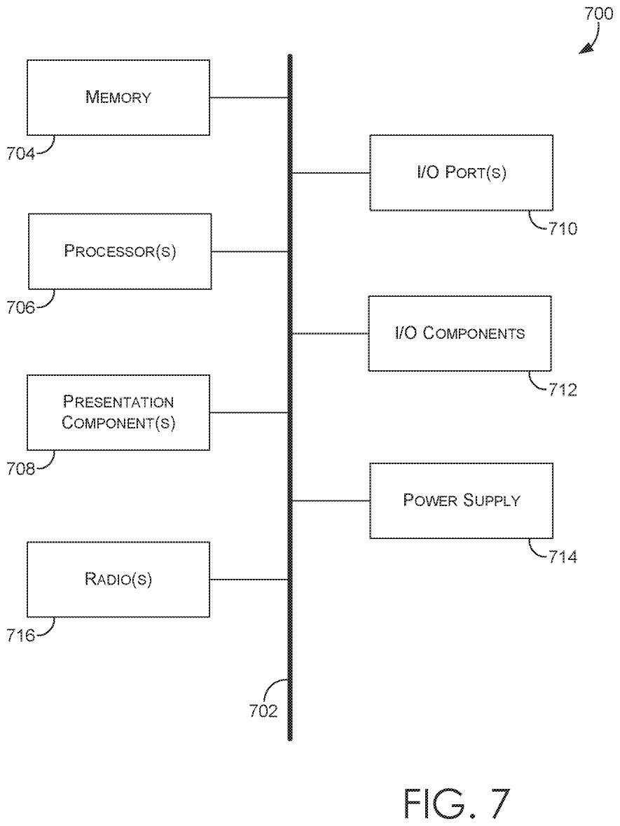

The VR scene transmission system 100 may include, among other things, source device(s) 102, client device(s) 104, server(s) 106, and a network 108. In any example, there may be any number of source device(s) 102, client device(s) 104, and server(s) 106. The VR scene transmission system 100 (and the components and/or features thereof) may be implemented using one or more computing devices, such as the computing device 700 of FIG. 7, described in more detail below.

The source device(s) 102 and/or client device(s) 104 may include a smart phone, VR headset, a laptop computer, a tablet computer, a desktop computer, and/or another type of device capable of generating and/or presenting video streams and/or 2D or 3D scenes (e.g., VR scenes). By way of example and not limitation, the source device(s) 102 and/or the client device(s) 104 may be embodied as a Personal Computer (PC), a laptop computer, a mobile device, a smartphone, a tablet computer, a smart watch, a wearable computer, a virtual reality device, an augmented reality device, any combination of these delineated devices, or any other suitable device.

The source device(s) 102 may include any device capable of generating, capturing, and/or transmitting media content. The source device(s) 102 may comprise a composer 120A, a renderer 130A, a scene instance 122, a display 112, and/or one or more input device(s) 118. Although only a few components and/or features of the source device(s) 102 are illustrated in FIG. 1, this is not intended to be limiting. For example, the source device(s) 102 may include additional or alternative components, such as those described with respect to the computing device 700 of FIG. 7.

The client device(s) 104 may comprise a composer 120B, a renderer 130B, a virtual camera controller 116, and a viewer 114. Although only a few components and/or features of the client device(s) 104 are illustrated in FIG. 1, this is not intended to be limiting. For example, the client device(s) 104 may include additional or alternative components, such as those described with respect to the computing device 700 of FIG. 7.

The server(s) 106 may comprise a composer 120C, a renderer 130C, and a streaming manager 132. Although only a few components and/or features of the server(s) 106 are illustrated in FIG. 1, this is not intended to be limiting. For example, the server(s) 106 may include additional or alternative components, such as those described with respect to the computing device 700 of FIG. 7.

The scene instance 122 is an instance of a 2D or 3D scene hosted and/or streamed by one or more source device(s) 102. For example, the scene instance 122 may be a 3D scene streamed from a source device 102 to one or more client device(s) 104. In some embodiments, the scene instance 122 includes VR data associated with the source device(s) 102. For instance, the scene instance 122 may comprise scene data and/or tracking data associated with the 3D scene and/or source device 102. As an example, the scene instance 122 may comprise scene data defining 3D objects within the 3D scene and may also comprise tracking data such as head position and movement, eye movement, hand position and movement, sound, and/or other data from one or more of the input device(s) 118 of the source device(s) 102. For example, head, hand, and eye tracking data collected by a VR headset and sensors associated with the source device(s) 102 may be included in the scene instance 122 along with other scene data defining a 3D scene.

The composer 120A, composer 120B, and composer 120C, (hereinafter “composers 120”), may comprise one or more components for composing, arranging, modifying, and/or navigating a 2D or 3D scene, for example, the 3D scene associated with the scene instance 122. For example, the composers 120 may define the arrangement and/or positioning of one or more 2D or 3D objects, scene components, cameras, actions, avatars, viewpoints, boundaries, and/or any other attribute associated with a scene. Scene attributes may be defined with view parameters that enable a 3D scene to be rendered according to the view parameters such that particular scene attributes are represented in the resulting rendering. For example, view parameters associated with a 3D scene may indicate the position and/or direction of one or more virtual camera for which the 3D scene may be rendered to represent the 3D scene from the perspective (e.g., field of view) of the one or more virtual cameras. In such an example, modifying the view parameters associated with a virtual camera may change the resulting perspective represented in the resulting render of the 3D scene.

A 2D or 3D scene may be composed by one or more composers 120 for rendering by any number of devices and/or in accordance with any number of view parameters and/or mappings to one or more physical environments. For example, one client device may compose a 3D scene according to a first set of view parameters, while another client device may compose that same 3D scene according to a distinct second set of view parameters. In such an example, the perspective of the 3D scene rendered by the first client device may be distinct form the perspective of the 3D scene rendered by the second client device. Similarly, a 3D scene composition of the composer 120A of a source device 102, may differ from the 3D scene compositions of the composer 120B and/or 120C of the client device(s) 104 and server(s) 106, respectively. In some embodiments, one or more of the composers 120 may receive an indication from the virtual camera controller 116 that directs the one or more composers 120 as to the placement and direction of one or more virtual cameras within a 2D or 3D scene. For example, a user may use the virtual camera controller 116 to define a virtual camera for a 3D scene that represents a particular viewing perspective that is of interest to the user.

The renderer 130A, renderer 130B, and renderer 130C, (hereinafter “renderers 130”), may comprise one or more components for generating a display or video representation of a 3D scene. For example, renderer 130A of the source device(s) 102, renderer 130B of the client device(s) 104, and renderer 130C of the server(s) 106 may be used to render 3D scenes according to one or more sets of view parameters determined by composer 120A, composer 120B, and composer 120C, respectively. Renderers 130 may be configured to render a representation of a 3D scene for display and/or presentation on the display 112 and/or viewer 114 of one or more source device(s) 102 and/or client device(s) 104.

Virtual camera controller 116 may comprise one or more components for defining the position, direction, rules, and/or other attributes associated with one or more virtual cameras within a 3D scene. For example, the virtual camera controller 116 may use one or more user inputs to the client device(s) 104 to generate and/or modify virtual cameras of a 3D scene. As an example, the position (e.g., the location of the camera within a 3D scene environment), the direction (e.g., the particular direction of focus or particular object to follow/focus on), field of view (e.g., viewing angles), depth of field, and/or any other attribute associated with a virtual camera may be defined, or otherwise adjusted, by the virtual camera controller 116. As an example, the virtual camera controller 116 can direct a virtual camera to follow a particular player character of a VR game within the 3D scene of the game such that the camera represents a “third person” perspective and focus on the player character.

Streaming manager 132 comprises one or more components for facilitating the streaming of VR data (e.g., tracking data, scene data, etc.) and/or a rendered representation of a 3D scene from one or more server(s) 106 to one or more client device(s) 104. For example, using the streaming manager 132, the sever(s) 106 may transmit VR data to a client device(s) 104 so that the VR data may be used by the composer 120B and the renderer 130B of the client device(s) 104 to render a representation of a 3D scene for display in the viewer 114. In certain embodiments, the server(s) 106 may use the composer 120C and the renderer 1130C to render a representation of a 3D scene prior to streaming to the client device(s) 104 using the streaming manager 132. In such an example, the streaming manager 132 may transmit a rendered 3D scene to the client device(s) 104.

Data store 110 may be used to store previously recorded media (e.g., VR game session within a 3D scene). For example, VR media from the source device(s) 102 associated with a 3D scene may be stored in the data store 110 such that the VR media may be accessed by the server(s) 106 and/or client device(s) 104 for playback or other interactions at a later time.

The input device(s) 118 may include any type of devices that are capable of providing user inputs to the scene instance 122. The input device(s) may include a keyboard, a mouse, a touch-screen display, a controller(s), a remote(s), a headset (e.g., sensors of a virtual reality headset), and/or other types of input devices.

The display 112 and/or viewer 114 may include any type of display capable of displaying the video (e.g., a light-emitting diode display (LED), an organic LED display (OLED), a liquid crystal display (LCD), an active matrix OLED display (AMOLED), a quantum dot display (QDD), a plasma display, an LED/LCD display, and/or another type of display). In some examples, the display 112 and/or viewer 114 may include more than one display (e.g., a dual-monitor display for computer gaming, a first display for configuring a game and a virtual reality display for playing the game, etc.).

Network 108 may be part of a communication network. In aspects, the network 108 may provide communication services from a service provider. The service provider may be a telecommunications service provider, an internet service provider, or any other similar service provider that provides at communication and/or data services to the source device(s) 102, client device(s) 104, and/or server(s) 106. For example, network 108 may be associated with a telecommunications provider that provides services (e.g., LTE, 5G NR) to the client device(s) 104, source device(s) 102, and/or server(s) 106. Additionally or alternatively, network 108 may provide voice, SMS, and/or data services to user devices or corresponding users that are registered or subscribed to utilize the services provided by a telecommunications provider. Network 108 may comprise any communication network providing voice, SMS, and/or data service(s), using any one or more wireless communication protocols, such as a 1× circuit voice, a 3G network (e.g., CDMA, CDMA2000, WCDMA, GSM, UMTS), a 4G network (WiMAX, LTE, HSDPA), or a 5G network. The network 108 may also be, in whole or in part, or have characteristics of, a self-optimizing network.

Having described VR scene transmission system 100 and components operating therein, it will be understood by those of ordinary skill in the art that the VR scene transmission system 100 is but an example of a suitable system and is not intended to limit the scope of use or functionality of aspects described herein. Similarly, VR scene transmission system 100 should not be interpreted as imputing any dependency and/or any requirements with regard to each component and combination(s) of components illustrated in FIG. 1. It will be appreciated by those of ordinary skill in the art that the number, interactions, and physical location of components illustrated in FIG. 1 is an example, as other methods, hardware, software, components, and devices for establishing one or more communication links between the various components may be utilized in implementations of the present invention. It will be understood to those of ordinary skill in the art that the components may be connected in various manners, hardwired or wireless, and may use intermediary components that have been omitted or not included in FIG. 1 for simplicity's sake. As such, the absence of components from FIG. 1 should not be interpreted as limiting the present invention to exclude additional components and combination(s) of components. Moreover, though components may be represented as singular components or may be represented in a particular quantity in FIG. 1 it will be appreciated that some aspects may include a plurality of devices and/or components such that FIG. 1 should not be considered as limiting the quantity of any device and/or component.

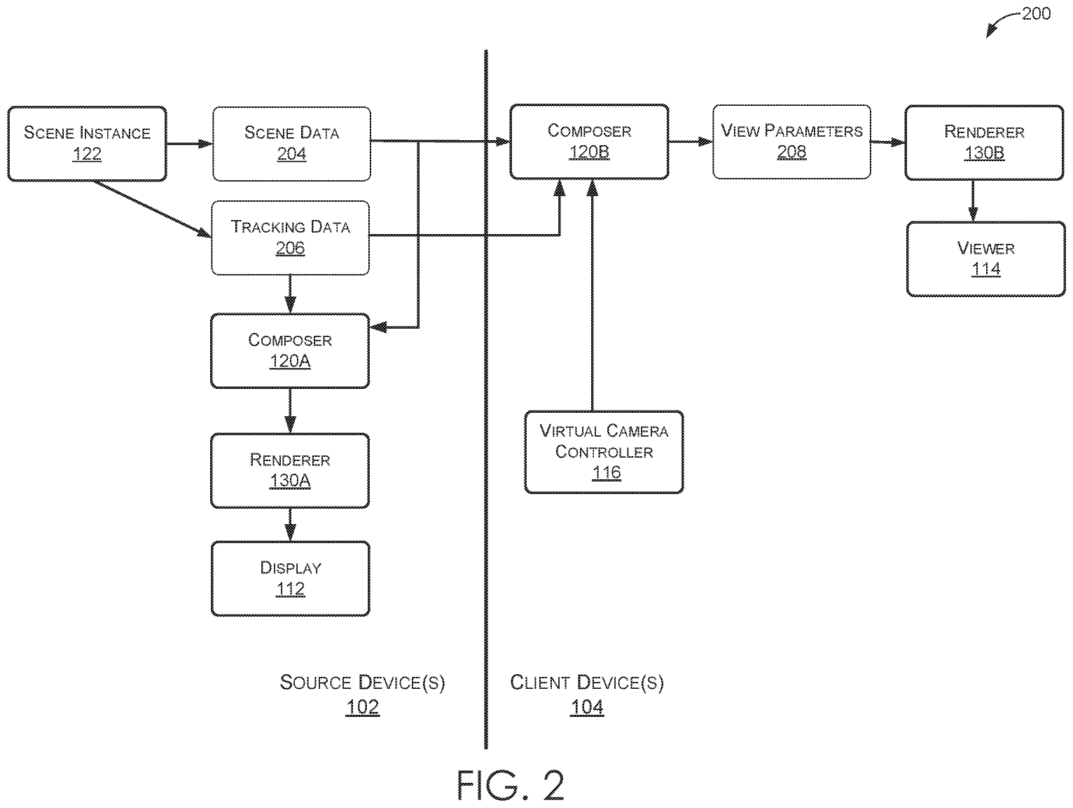

FIG. 2 depicts an example process 200 for lossless VR streaming, in accordance with embodiments of the present disclosure. The process 200 may be implemented using the VR scene transmission system 100 of FIG. 1. For example, the scene data 204 and the tracking data 206 may be generated by the scene instance 122 of FIG. 1. The view parameters 208 may be determined by composer 120B of the client device(s) 104 of FIG. 1. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Scene data 204 and tracking data 206 may be generated using a scene instance 122 of a 3D scene associated with one or more source device(s) 102. The scene data 204 and the tracking data 206 may be used by the composer 120A to determine a set of view parameters that can be used by the renderer 130A to render a representation of the 3D scene associated with the scene instance 122. In some embodiments, the composer 120A and the renderer 130A may be used to generate a rendering of a 3D scene for presentation in the display 112 of the source device(s) 102.

The scene data 204 and the tracking data 206 generated from the scene instance 122 may be used by the composer 120B of the client device(s) 104 to compose the 3D scene in accordance to the client device(s) 104. In some embodiments, the composition of the 3D scene generated by the composer 120B of the client device(s) 104 may be different from the composition of the 3D scene generated by the composer 120A of the source device(s) 102. The composer 120B may use instructions from the virtual camera controller 116 along with the scene data 204 and the tracking data 206 to determine a set of view parameters 208 that can be used by the renderer 130B of the client device(s) 104. The renderer 130B may use the view parameters 208, to generate a rendering of a representation of a 3D scene in accordance with the view parameters 208 and the client device(s) 104. The rendering generated by the renderer 130B may be presented in the viewer 114 of the client device(s) 104.

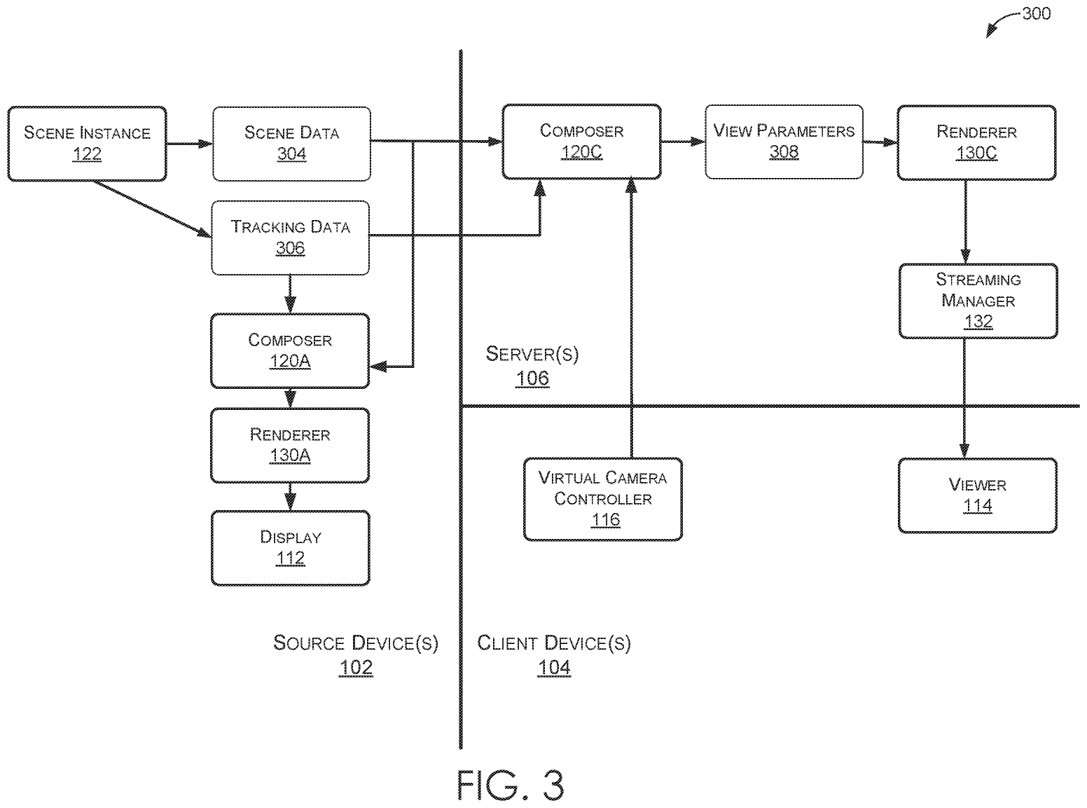

FIG. 3 depicts an example process 300 for lossless VR streaming with pre-rendering, in accordance with embodiments of the present disclosure. The process 300 may be implemented using the VR scene transmission system 100 of FIG. 1. For example, the scene data 304 and the tracking data 306 may be generated by the scene instance 122 of FIG. 1. The view parameters 308 may be determined by composer 120B of the client device(s) 104 of FIG. 1. It should be understood that this and other arrangements described herein are set forth only as examples. Other arrangements and elements (e.g., machines, interfaces, functions, orders, groupings of functions, etc.) can be used in addition to or instead of those shown, and some elements may be omitted altogether. Further, many of the elements described herein are functional entities that may be implemented as discrete or distributed components or in conjunction with other components, and in any suitable combination and location. Various functions described herein as being performed by entities may be carried out by hardware, firmware, and/or software. For instance, various functions may be carried out by a processor executing instructions stored in memory.

Scene data 304 and tracking data 306 may be generated using a scene instance 122 of a 3D scene associated with one or more source device(s) 102. The scene data 304 and the tracking data 306 may be used by the composer 120A to determine a set of view parameters that can be used by the renderer 130A to render a representation of the 3D scene associated with the scene instance 122. In some embodiments, the composer 120A and the renderer 130A may be used to generate a rendering of a 3D scene for presentation in the display 112 of the source device(s) 102.

The scene data 304 and the tracking data 306 generated from the scene instance 122 may be used by the composer 120C of the server(s) 106 to compose the 3D scene in accordance to the client device(s) 104. In some embodiments, the composition of the 3D scene generated by the composer 120C of the server(s) 106 may be different from the composition of the 3D scene generated by the composer 120A of the source device(s) 102. The composer 120C may use instructions from the virtual camera controller 116 of the client device(s) 104 along with the scene data 304 and the tracking data 306 to determine a set of view parameters 308 that can be used by the renderer 130C of the server(s) 106. The renderer 130C may use the view parameters 308, to generate a rendering of a representation of a 3D scene in accordance with the view parameters 308 and the client device(s) 104. Once the rendering is generated by the renderer 130C, the rendering may be transmitted to the client device(s) 104 using the streaming manager 132 of the server(s) 106. Once the client device(s) 104 receive the rendered 3D scene, it may be presented in the viewer 114 of the client device(s) 104.

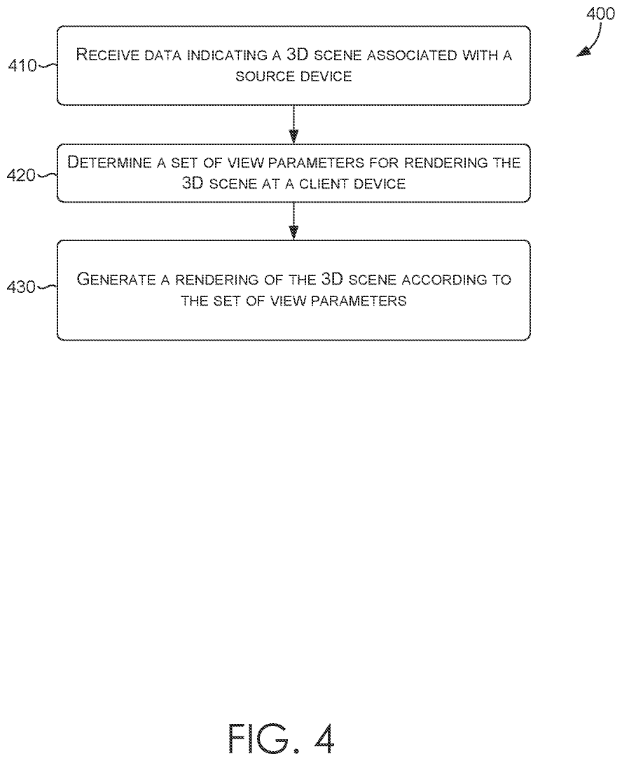

Now referring to FIGS. 4-6, each block of methods 400, 500, and 600, described herein, comprises a computing process that may be performed using any combination of hardware, firmware, and/or software. For instance, various functions may be carried out by a processor executing instructions stored in memory. The methods 400, 500, and 600 may also be embodied as computer-usable instructions stored on computer storage media. The methods 400, 500, and 600 may be provided by a standalone application, a service or hosted service (standalone or in combination with another hosted service), or a plug-in to another product, to name a few. In addition, the methods 400, 500, and 600 are described, by way of example, with respect to the system of FIG. 1. However, these methods may additionally or alternatively be executed by any one system, or any combination of systems, including, but not limited to, those described herein.

FIG. 4 is a flow chart illustrating an example method 400 for generating a 3D rendering, in accordance with aspects of the present disclosure. It should be understood that while FIG. 4 depicts just one particular arrangement and/or order of steps, other arrangements and/or orders of steps are possible and contemplated by the disclosed herein. For instance, one or more of the steps depicted in FIG. 4, may be performed in a different order or otherwise omitted.

At step 410 of the method 400, data indicating a 3D scene associated with a source device may be received, for example by the client device(s) 104 of FIG. 1. The client device(s) 104 may receive data associated with a 3D scene that comprise scene data and/or tracking data associated with source device(s) 102. For example, the input device(s) 118 of the source device(s) 102 may capture tracking data such as head and/or arm movement or position. In some embodiments, the data may be received by the server(s) 106 and one or more client device(s) 104.

At step 420 of method 400, a set of view parameters for rendering the 3D scene at a client device is determined. For example, the composer 120B of the client device(s) 104 or the composer 120C of the server(s) may determine view parameters that may be used by the renderer 130B or renderer 130C to render a representation of the 3D scene for presentation at the client device(s) 104. In some embodiments, information received from the virtual camera controller 116 may be used to determine the set of view parameters.

At step 430 of the method 400, a rendering of the 3D scene is generated according to the set of view parameters. For example, the renderer 130B and/or renderer 130C may use the set of view parameters determined by the composers 120B and 120C respectively, to generate a rendering of a 3D scene.

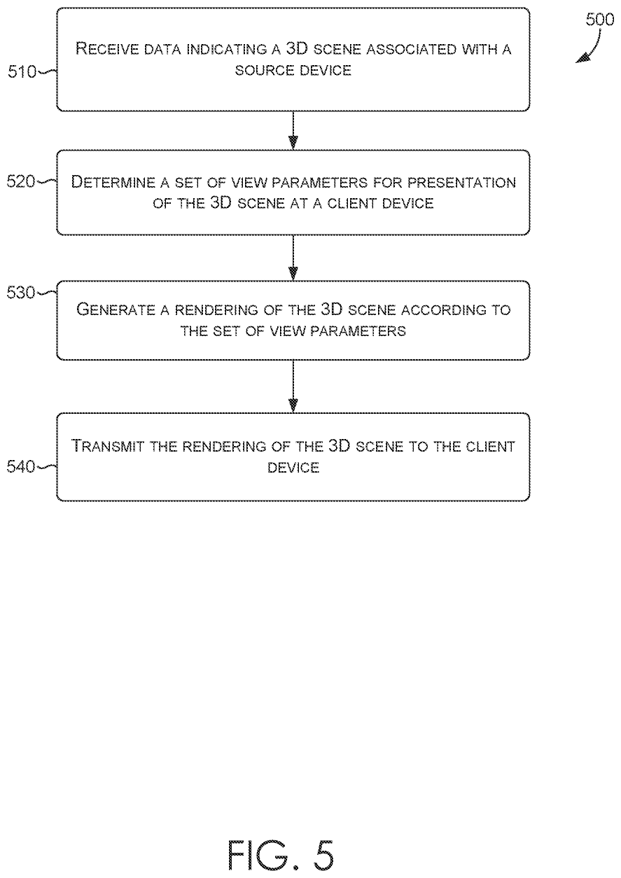

FIG. 5 is a flow chart illustrating an example method 500 for transmitting lossless 3D renderings, in accordance with aspects of the present disclosure. It should be understood that while FIG. 5 depicts just one particular arrangement and/or order of steps, other arrangements and/or orders of steps are possible and contemplated by the disclosed herein. For instance, one or more of the steps depicted in FIG. 5, may be performed in a different order or otherwise omitted.

In step 510 of method 500, data indicating a 3D scene associated with a source device may be received. For example, the server(s) 106 of FIG. 1 may receive data associated with a 3D scene that comprise scene data and/or tracking data associated with source device(s) 102. For example, the input device(s) 118 of the source device(s) 102 may capture tracking data such as head and/or arm movement or position. In some embodiments, the data may be received by the server(s) 106 and one or more client device(s) 104.

At step 520 of the method 500, a set of view parameters for presentation of the 3D scene at a client device is determined. For example, the composer 120C of the server(s) may determine view parameters that may be used by the renderer 130C to render a representation of the 3D scene for presentation at the client device(s) 104. In some embodiments, information received from the virtual camera controller 116 of the client device(s) 104 may be used to determine the set of view parameters.

At step 530 of the method 500, a rendering of the 3D scene is generated according to the set of view parameters. For example, the renderer 130C may use the set of view parameters determined by the composer 120C to generate a rendering of a 3D scene.

At step 540 of the method 500, the rendering of the 3D scene may be transmitted to the client device. For example, using the streaming manager 132, the server(s) 106 may transmit a rendered representation of a 3D scene to one or more client device(s) 104 causing the client device(s) 104 to present the rendering in the viewer 114.

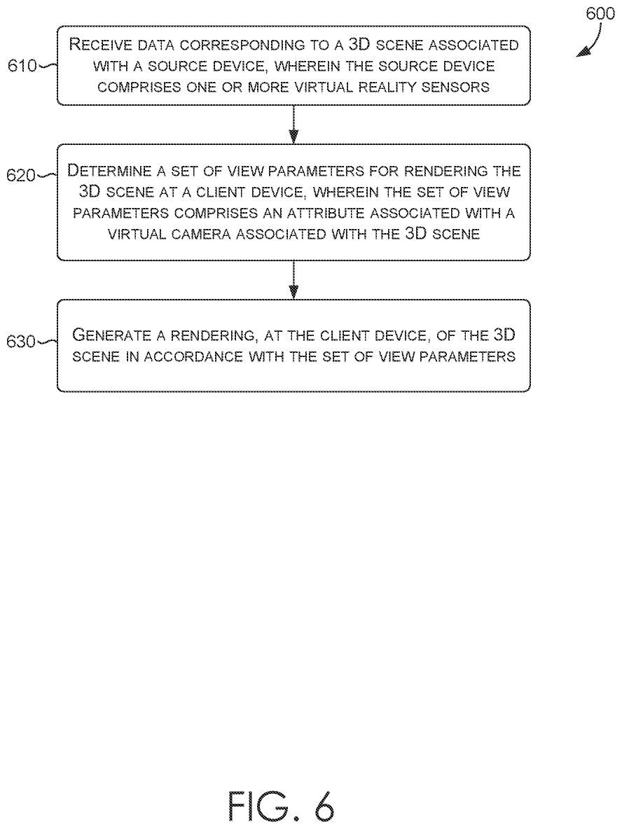

FIG. 6 is a flow chart illustrating an example method 600 for streaming 3D VR media, in accordance with aspects of the present disclosure. It should be understood that while FIG. 6 depicts just one particular arrangement and/or order of steps, other arrangements and/or orders of steps are possible and contemplated by the disclosed herein. For instance, one or more of the steps depicted in FIG. 6, may be performed in a different order or otherwise omitted.

At step 610 of method 600, data corresponding to a 3D scene associated with a source device may be received, wherein the source device comprises one or more virtual reality sensors. For example, the client device(s) 104 of FIG. 1 may receive data corresponding to a 3D scene that associated with source device(s) 102 that may be generated by VR sensors of the input device(s) 118.

At step 620 of the method 600, a set of view parameters for rendering the 3D scene at a client device is determined, wherein the set of view parameters comprise an attribute associate with a virtual camera associated with the 3D scene. For example, the composer 120B of the client device(s) 104 may use information from the virtual camera controller 116 to determine view parameters that may be used by the renderer 130B to render a representation of the 3D scene for presentation on the client device(s) 104.

At step 630 of the method 600, a rendering of the 3D scene is generated, at the client device, in accordance to the set of view parameters. For example, the renderer 130B may use the set of view parameters determined by the composer 120B, to generate a rendering of a 3D scene.

Referring now to FIG. 7, a diagram is depicted of an exemplary computing environment suitable for use in implementations of the present disclosure. In particular, the exemplary computer environment is shown and designated generally as computing device 700. Computing device 700 is but one example of a suitable computing environment and is not intended to suggest any limitation as to the scope of use or functionality of the invention. Neither should computing device 700 be interpreted as having any dependency or requirement relating to any one or combination of components illustrated.

The implementations of the present disclosure may be described in the general context of computer code or machine-useable instructions, including computer-executable instructions such as program components, being executed by a computer or other machine, such as a personal data assistant or other handheld device. Generally, program components, including routines, programs, objects, components, data structures, and the like, refer to code that performs particular tasks or implements particular abstract data types. Implementations of the present disclosure may be practiced in a variety of system configurations, including handheld devices, consumer electronics, general-purpose computers, specialty computing devices, etc. Implementations of the present disclosure may also be practiced in distributed computing environments where tasks are performed by remote-processing devices that are linked through a communications network.

With continued reference to FIG. 7, computing device 700 includes bus 702 that directly or indirectly couples the following devices: memory 704, one or more processors 706, one or more presentation components 708, input/output (I/O) ports 710, I/O components 712, power supply 714 and radio(s) 716. Bus 702 represents what may be one or more busses (such as an address bus, data bus, or combination thereof). Although the devices of FIG. 7 are shown with lines for the sake of clarity, in reality, delineating various components is not so clear, and metaphorically, the lines would more accurately be grey and fuzzy. For example, one may consider a presentation component, such as a display device to be one of I/O components 712. Also, processors, such as one or more processors 706, have memory. The present disclosure hereof recognizes that such is the nature of the art, and reiterates that FIG. 7 is merely illustrative of an exemplary computing environment that can be used in connection with one or more implementations of the present disclosure. Distinction is not made between such categories as “workstation,” “server,” “laptop,” “handheld device.” etc., as all are contemplated within the scope of FIG. 7 and refer to “computer” or “computing device.”

Computing device 700 typically includes a variety of computer-readable media. Computer-readable media can be any available media that can be accessed by computing device 700 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information, such as computer-readable instructions, data structures, program modules, or other data.

Computer storage media includes RAM, ROM, EEPROM, flash memory or other memory technology, CD-ROM, DVD or other optical disk storage, magnetic cassettes, magnetic tape, magnetic disk storage, or other magnetic storage devices. Computer storage media does not comprise a propagated data signal.

Communication media typically embodies computer-readable instructions, data structures, program modules, or other data in a modulated data signal, such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media such as acoustic, RF, infrared, and other wireless media. Combinations of any of the above should also be included within the scope of computer-readable media.

Memory 704 includes computer-storage media in the form of volatile and/or nonvolatile memory. Memory 704 may be removable, non-removable, or a combination thereof. Exemplary memory includes solid-state memory, hard drives, optical-disc drives, etc. Computing device 700 includes one or more processors 706 that read data from various entities, such as bus 702, memory 704, or I/O components 712. One or more presentation components 708 presents data indications to a person or other device. Exemplary one or more presentation components 708 include a display device, speaker, printing component, vibrating component, etc. I/O ports 710 allow computing device 700 to be logically coupled to other devices, including I/O components 712, some of which may be built in computing device 700. Illustrative I/O components 712 include a microphone, joystick, game pad, satellite dish, scanner, printer, wireless device, etc.

Radio(s) 716 represents a radio that facilitates communication with a wireless telecommunications network. Illustrative wireless telecommunications technologies include CDMA, GPRS, TDMA, GSM, and the like. Radio 716 might additionally or alternatively facilitate other types of wireless communications including Wi-Fi, WiMAX, LTE, or other VoIP communications. As can be appreciated, in various embodiments, radio 716 can be configured to support multiple technologies and/or multiple radios can be utilized to support multiple technologies. A wireless telecommunications network might include an array of devices, which are not shown so as to not obscure more relevant aspects of the invention. Components, such as a base station, a communications tower, or even access points (as well as other components), can provide wireless connectivity in some embodiments.

Many different arrangements of the various components depicted, as well as components not shown, are possible without departing from the scope of the claims below. Embodiments of this technology have been described with the intent to be illustrative rather than be restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

The invention claimed is:

1. A method comprising:
receiving data indicating a 3D scene associated with a source device;
determining a set of view parameters for rendering the 3D scene at a client device, and
generating a rendering of the 3D scene according to the set of view parameters.

2. The method of claim 1, further comprising transmitting the rendering to the client device causing the client device to display the rendering of the 3D scene.

3. The method of claim 1, wherein determining the set of view parameters comprises receiving virtual camera data associated with the client device.

4. The method of claim 1, wherein the method further comprises:
receiving tracking data associated with the source device; and
using the tracking data to determine the set of view parameters.

5. The method of claim 1, wherein generating the rendering is performed by the client device.

6. The method of claim 1, wherein the 3D scene associated with the source device is mapped to a first physical environment and the rendering is mapped to a second physical environment.

7. The method of claim 1, further comprising determining a second set of view parameters for rendering the 3D scene at a second client device; and
Generating a second rendering of the 3D scene according to the second set of view parameters.

8. The method of claim 1, wherein the data indicating the 3D scene associated with the source device is generated using at least a virtual reality device.

9. A system comprising:
one or more processors; and
one or more computer storage hardware devices storing computer-usable instructions that, when used by the one or more processors, cause the one or more processors to:
receive data indicating a 3D scene associated with a source device;
determine a set of view parameters for presentation of the 3D scene at a client device;
generating a rendering of the 3D scene according to the set of view parameters; and
transmitting the rendering of the 3D scene to the client device.

10. The system of claim 9, wherein transmitting the rendering of the 3D scene to the client device causes the client device to display the rendering of the 3D scene.

11. The system of claim 9, wherein determining the set of view parameters comprises receiving virtual camera data associated with the client device.

12. The system of claim 9, wherein the data indicating the 3D scene comprises virtual reality (“VR”) tracking data associated with the source device used to determine the set of view parameters.

13. The system of claim 9, wherein the 3D scene associated with the source device is mapped to a first physical environment and the rendering is mapped to a second physical environment associated with the client device.

14. The system of claim 9, wherein a second set of view parameters for presentation of the 3D scene at a second client device is determined and a second rendering of the 3D scene is rendered according to the second set of view parameters.

15. The system of claim 9, wherein the data indicating the 3D scene associated with the source device is generated using at least a virtual reality device.

16. One or more computer-readable media having computer-executable instructions embodied thereon that, when executed, perform a method comprising:
receive data corresponding to a 3D scene associated with a source device, wherein the source device comprises one or more virtual reality (“VR”) sensors;
determining a set of view parameters for rendering the 3D scene at a client device, wherein the set of view parameters comprises an attribute associated with a virtual camera associated with the 3D scene; and
generating a rendering, at the client device, of the 3D scene in accordance with the set of view parameters.

17. The media of claim 16, wherein the 3D scene associated with the source device is mapped to a first physical environment and the rendering is mapped to a second physical environment associated with the client device.

18. The media of claim 16, wherein the rendering is presented in a user interface of the client device.

19. The media of claim 16, wherein the method further comprises determining a second set of view parameters for rendering the 3D scene at a second client device and generating a second rendering, at the second client devices, of the 3D scene in accordance with the second set of view parameters.

20. The media of claim 16, wherein the attribute associated with the virtual camera comprises a position, direction, field of view, depth of field, or tracked object.
